(19) United States
(12) Patent Application Publication
(10) Pub. No.: US 2017/0122244 A1
(43) Pub. Date: May 4, 2017

(54) VEHICLES AND METHODS FOR CONTROLLING INTERNAL COMBUSTION ENGINE ROTATIONAL SPEEDS

(71) Applicant: Toyota Motor Engineering & Manufacturing North America, Inc., Erlanger, KY (US)

(72) Inventor: Mohammad E. Dufford, Los Angeles, CA (US)

(73) Assignee: Toyota Motor Engineering & Manufacturing North America, Inc., Erlanger, KY (US)

(21) Appl. No.: 14/925,118

(22) Filed: Oct. 28, 2015

(51) Int. Cl. F02D 41/26; B60W 10/06; B60W 10/08; B60K 6/445; B60W 10/26; B60K 6/365; B60K 6/24; B60K 6/26; F02D 11/10; B60W 20/10

(52) U.S. Cl. CPC F02D 41/263; F02D 11/105; B60W 10/06; B60W 10/08; B60W 20/10; B60W 10/26; B60K 6/365; B60K 6/24; B60K 6/26; B60K 6/445; B60W 2720/30; B60W 2710/0661; B60W 2710/242; B60W 2540/10; B60W 2520/10; B60W 2720/106; B60W 2710/083; B60Y 2400/604; B60Y 2400/61; B60Y 2200/92; B60Y 2300/1882; Y10S 903/905; Y10S 903/906; Y10S 903/91; Y10S 903/951

(57) ABSTRACT

Vehicles and methods for controlling internal combustion engine rotational speeds are disclosed. Vehicles described herein include an internal combustion engine having a crankshaft and a plurality of drive wheels mechanically coupled to the crankshaft of the internal combustion engine. Embodiments described herein determine a target wheel torque, determine a base increase rate of engine rotational speed, increase an engine rotational speed of the internal combustion engine based on the base increase rate of engine rotational speed, determine an estimated wheel torque, determine an updated increase rate of engine rotational speed based on the target wheel torque and the estimated wheel torque, and increase the engine rotational speed of the internal combustion engine based on the updated increase rate of engine rotational speed.

### TECHNICAL FIELD

The present specification generally relates to vehicle control and, more specifically, to vehicles and methods for controlling internal combustion engine rotational speeds.

### BACKGROUND

Many vehicles, including conventional vehicles and hybrid vehicles, include internal combustion engines that generate power to propel the vehicles by rotating drive wheels of the vehicles. In order to manage different power needs of a vehicle under different driving conditions, a rotational speed of the internal combustion engine may need to be changed. It may be desirable to control the rate of change of the rotational speed of internal combustion engines.

Accordingly, a need exists for vehicles and methods for controlling internal combustion engine rotational speeds.

### SUMMARY

In one embodiment, a vehicle includes one or more processors, one or more memory modules communicatively coupled to the one or more processors, an internal combustion engine comprising a crankshaft, a plurality of drive wheels mechanically coupled to the crankshaft of the internal combustion engine, and machine readable instructions stored in the one or more memory modules. The internal combustion engine is communicatively coupled to the one or more processors. When executed by the one or more processors, the machine readable instructions cause the vehicle to determine a target wheel torque, determine a base increase rate of engine rotational speed, increase an engine rotational speed of the internal combustion engine based on the base increase rate of engine rotational speed, determine an estimated wheel torque, determine an updated increase rate of engine rotational speed based on the target wheel torque and the estimated wheel torque, and increase the engine rotational speed of the internal combustion engine based on the updated increase rate of engine rotational speed.

In another embodiment, a hybrid vehicle includes one or more processors, one or more memory modules communicatively coupled to the one or more processors, a mechanical power distribution apparatus, an internal combustion engine comprising a crankshaft, a plurality of drive wheels, a first motor-generator comprising an output shaft, a second motor-generator comprising an output shaft, an electrical energy storage device electrically coupled to the first motor-generator and the second motor-generator such that the electrical energy storage device can provide electrical energy to the first motor-generator and the second motor-generator, and machine readable instructions stored in the one or more memory modules. The mechanical power distribution apparatus includes a sun gear, a plurality of planetary gears, a carrier, and a ring gear. The plurality of planetary gears mesh with the ring gear and the sun gear. The plurality of planetary gears are mechanically coupled to the carrier. The crankshaft is mechanically coupled to the carrier of the mechanical power distribution apparatus. The output shaft of the first motor-generator is mechanically coupled to the sun gear. The output shaft of the second motor-generator is mechanically coupled to the plurality of drive wheels and is mechanically coupled to the ring gear. When executed by the one or more processors, the machine readable instructions cause the hybrid vehicle to determine a target wheel torque, determine a base increase rate of engine rotational speed, increase an engine rotational speed of the internal combustion engine by controlling an amount of electrical energy provided from the electrical energy storage device to the first motor-generator based on the base increase rate of engine rotational speed, determine an estimated wheel torque, determine an updated increase rate of engine rotational speed based on the target wheel torque and the estimated wheel torque, and increase the engine rotational speed of the internal combustion engine by controlling the amount of electrical energy provided from the electrical energy storage device to the first motor-generator based on the updated increase rate of engine rotational speed.

In yet another embodiment, a method for controlling an engine rotational speed of an internal combustion engine includes determining a target wheel torque, determining a base increase rate of engine rotational speed, increasing the engine rotational speed of the internal combustion engine based on the base increase rate of engine rotational speed, determining an estimated wheel torque, determining an updated increase rate of engine rotational speed based on the target wheel torque and the estimated wheel torque, and increasing the engine rotational speed of the internal combustion engine based on the updated increase rate of engine rotational speed.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a hybrid vehicle including an internal combustion engine, a first motor-generator, and an electrical energy storage device, according to one or more embodiments shown and described herein;

FIG. 2 schematically depicts an electrical energy distribution device including a DC-DC converter, a first inverter, and a second inverter, according to one or more embodiments shown and described herein;

FIG. 3 schematically depicts a vehicle including an internal combustion engine, according to one or more embodiments shown and described herein; and

FIG. 4 schematically depicts a method for controlling an internal combustion engine rotational speed, according to one or more embodiments shown and described herein.

### DETAILED DESCRIPTION

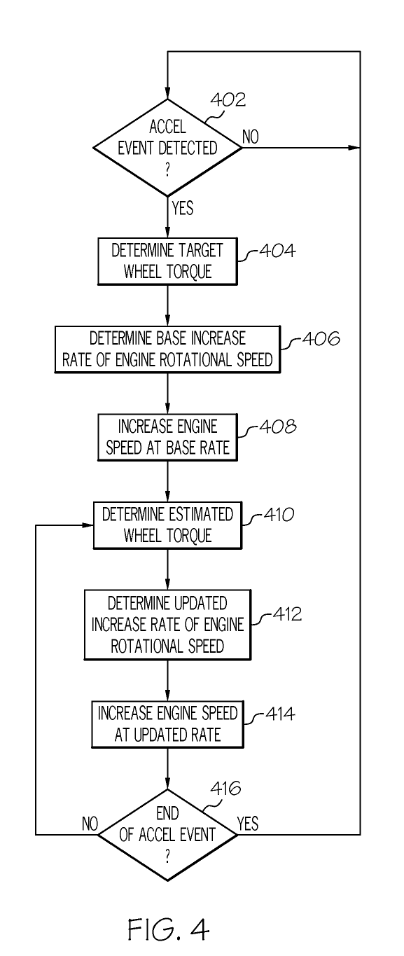

The embodiments disclosed herein include vehicles and methods for controlling internal combustion engine rotational speeds. Referring generally to FIG. 4, embodiments described herein determine a target wheel torque, determine a base increase rate of engine rotational speed, increase an engine rotational speed of the internal combustion engine based on the base increase rate of engine rotational speed, determine an estimated wheel torque, determine an updated increase rate of engine rotational speed based on the target wheel torque and the estimated wheel torque, and increase the engine rotational speed of the internal combustion engine based on the updated increase rate of engine rotational speed. By adaptively changing the increase rate of engine rotational speed based on estimated wheel torque and target wheel torque as described herein, vehicles may achieve a smoother acceleration profile in some instances and may achieve a variety of acceleration profiles under different driving conditions. Furthermore, embodiments described herein may provide for different acceleration profiles under different driving conditions (e.g. different acceleration profiles at different requested vehicle acceleration amounts and vehicle speeds), which may allow for achieving a target top speed more quickly in some instances despite a potential acceleration lag (e.g., when merging onto a highway at a higher vehicle speed), and may allow for achieving an initial acceleration quickly with reduced lag despite a longer time to reach a top target speed (e.g., when driving in heavy traffic at a lower vehicle speed). The various vehicles and methods for controlling internal combustion engine rotational speeds will be described in more detail herein with specific reference to the corresponding drawings.

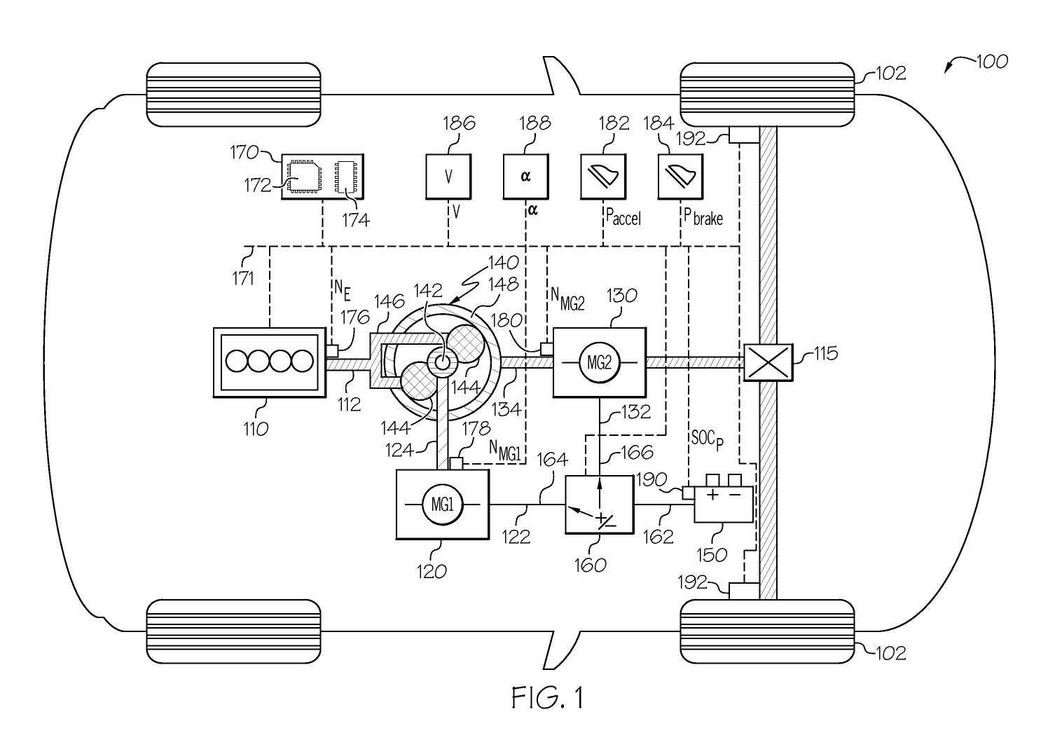

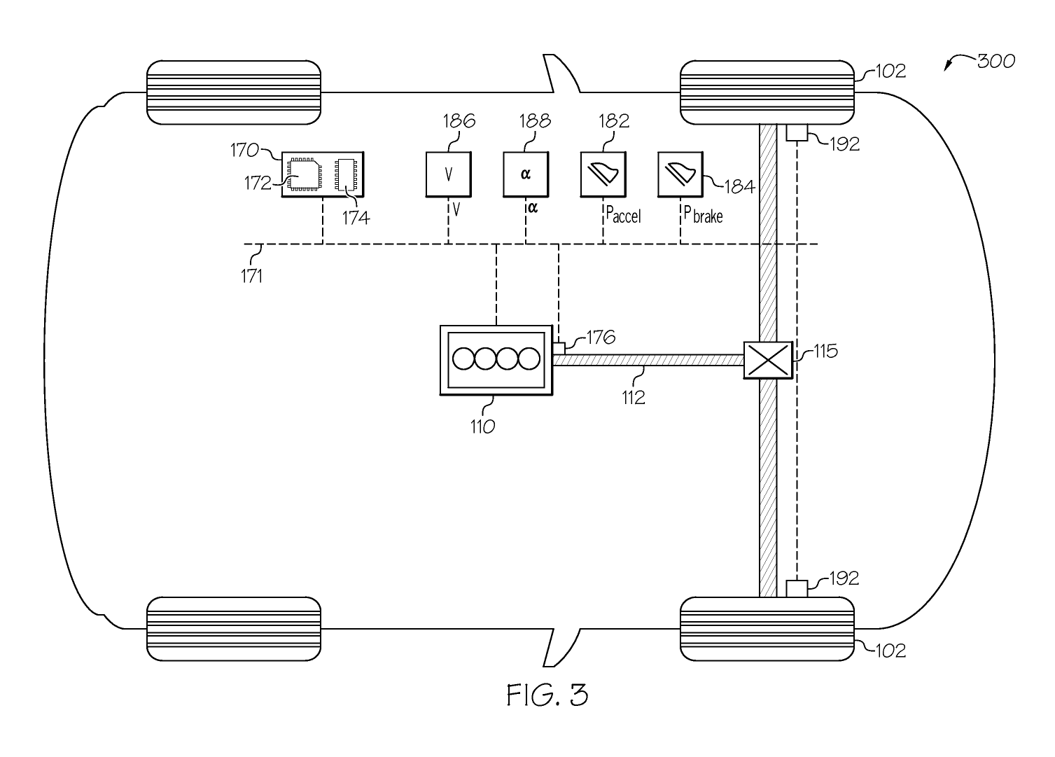

The embodiments described herein are applicable to a variety of vehicles, including conventional vehicles, hybrid vehicles, vehicles having CVT transmissions, and the like. Hybrid vehicle embodiments will be described with reference to FIG. 1 and conventional vehicle embodiments will be described with reference to FIG. 3, though the control schemes and methods described herein are not limited to the particular vehicle architectures and/or components described herein.

Referring now to FIG. 1, an embodiment of a hybrid vehicle 100 is schematically depicted. The hybrid vehicle 100 includes a plurality of drive wheels 102, a differential gear 115, an internal combustion engine 110, a first motor-generator 120, a second motor-generator 130, a mechanical power distribution apparatus 140, an electrical energy storage device 150, an electrical energy distribution device 160, an electronic control unit 170, a communication path 171, and a number of sensors configured to sense a number of parameters associated with the operation of the hybrid vehicle 100. The various components of the hybrid vehicle 100 will now be described.

Still referring to FIG. 1, the internal combustion engine 110 converts thermal energy released by controlled combustion of fuel into mechanical energy, which may be used by the hybrid vehicle 100 for a number of purposes, such as to rotate the plurality of drive wheels 102 of the hybrid vehicle 100. In some embodiments, the fuel combusted by the internal combustion engine 110 is gasoline or diesel oil. In some embodiments, the fuel combusted by the internal combustion engine 110 may be another type of fuel, such as propane, natural gas, ethanol, biodiesel, hydrogen, or any other fuel that may be combusted within the internal combustion engine 110 to produce thermal energy that may be converted into mechanical energy usable by the hybrid vehicle 100. The internal combustion engine 110 includes a crankshaft 112 that is caused to rotate by the combustion of the fuel within the internal combustion engine 110. In some embodiments, the crankshaft 112 converts reciprocating motion of one or more pistons driven by combustion of fuel within one or more cylinders.

Still referring to FIG. 1, the first motor-generator 120 is a machine that converts between electrical energy and mechanical energy. The first motor-generator 120 includes an electrical energy port 122 and an output shaft 124. The first motor-generator 120 is capable of operating in a motor mode and in a generator mode. When the first motor-generator 120 operates in the motor mode, electrical energy is received at the electrical energy port 122 and converted to mechanical energy when the output shaft 124 rotates in response to the electrical energy received at the electrical energy port 122. When the first motor-generator 120 operates in the generator mode, mechanical energy is received at the output shaft 124, the mechanical energy received at the output shaft 124 causes the output shaft 124 to rotate, and the mechanical energy of the rotating output shaft 124 is converted to electrical energy that is output at the electrical energy port 122. In the embodiment depicted in FIG. 1, the first motor-generator 120 is a synchronous motor-generator that, when operating in the motor mode, is driven by alternating current. When the first motor-generator 120 is driven by alternating current, the rotation of the output shaft 124 is synchronized with the frequency of the alternating current received at the electrical energy port 122. In other embodiments, the first motor-generator 120 is not a synchronous motor-generator, such as embodiments in which the first motor-generator 120 is an induction motor-generator.

Still referring to FIG. 1, the second motor-generator 130 is a machine that converts between electrical energy and mechanical energy. The second motor-generator 130 includes an electrical energy port 132 and an output shaft 134. The second motor-generator 130 is capable of operating in a motor mode and in a generator mode. When the second motor-generator 130 operates in the motor mode, electrical energy is received at the electrical energy port 132 and converted to mechanical energy when the output shaft 134 rotates in response to the electrical energy received at the electrical energy port 132. When the second motor-generator 130 operates in the generator mode, mechanical energy is received at the output shaft 134, the mechanical energy received at the output shaft 134 causes the output shaft 134 to rotate, and the mechanical energy of the rotating output shaft 134 is converted to electrical energy that is output at the electrical energy port 132. In the embodiment depicted in FIG. 1, the second motor-generator 130 is a synchronous motor-generator that, when operating in the motor mode, is driven by alternating current. When the second motor-generator 130 is driven by alternating current, the rotation of the output shaft 134 is synchronized with the frequency of the alternating current received at the electrical energy port 132. In other embodiments, the second motor-generator 130 is not a synchronous motor-generator, such as embodiments in which the second motor-generator 130 is an induction motor-generator.

Still referring to FIG. 1, the mechanical power distribution apparatus 140 includes a sun gear 142, a plurality of planetary gears 144, a carrier 146, and a ring gear 148. The plurality of planetary gears 144 meshes with the sun gear 142 such that the plurality of planetary gears 144 and the sun gear 142 may rotate relative to one another. The plurality of planetary gears 144 also meshes with the ring gear 148 such that the plurality of planetary gears 144 and the ring gear 148 may rotate relative to one another. The plurality of planetary gears 144 is mechanically coupled to the carrier 146 such that the carrier 146 rotates as the plurality of planetary gears 144 rotate relative to the sun gear 142 or the ring gear 148.

Still referring to the mechanical power distribution apparatus 140 depicted in FIG. 1, the sun gear 142 is mechanically coupled to the output shaft 124 of the first motor-generator 120 such that a rotational speed of the sun gear 142 is proportional to a rotational speed of the output shaft 124 of the first motor-generator 120. In some embodiments, the rotational speed of the sun gear 142 is the same as the rotational speed of the output shaft 124 of the first motor-generator 120, though embodiments are not limited thereto.

Still referring to the mechanical power distribution apparatus 140 depicted in FIG. 1, the plurality of planetary gears 144 are mechanically coupled to the carrier 146, which in turn is mechanically coupled to the crankshaft 112 of the internal combustion engine 110 such that a rotational speed of the crankshaft 112 of the internal combustion engine 110 is proportional to a rotational speed of the carrier 146. In some embodiments, the rotational speed of the crankshaft 112 of the internal combustion engine 110 is the same as the rotational speed of the carrier 146, though embodiments are not limited thereto.

Still referring to the mechanical power distribution apparatus 140 depicted in FIG. 1, the ring gear 148 is mechanically coupled to the output shaft 134 of the second motor-generator 130 such that a rotational speed of the output shaft 134 of the second motor-generator 130 is proportional to a rotational speed of the ring gear 148. In some embodiments, the rotational speed of the ring gear 148 is the same as the rotational speed of the output shaft 134 of the second motor-generator 130, though embodiments are not limited thereto. The output shaft 134 of the second motor-generator 130 is also mechanically coupled to a plurality of drive wheels 102 such that a rotational speed of the output shaft 134 of the second motor-generator 130 is proportional to a rotational speed of the plurality of drive wheels 102. Accordingly, the rotational speed of the plurality of drive wheels 102, the rotational speed of the output shaft 134 of the second motor-generator 130 and the rotational speed of the ring gear 148 are all proportional to one another. In the embodiment depicted in FIG. 1, the output shaft 134 of the second motor-generator 130 is mechanically coupled to a differential gear 115, which in turn is mechanically coupled to the plurality of drive wheels 102, though in other embodiments the output shaft 134 of the second motor-generator 130 may be mechanically coupled to the plurality of drive wheels 102 in another manner. Some embodiments may include additional components in the drive train of the hybrid vehicle 100. For example, some embodiments may include a flywheel and/or a damper mechanically coupled to the crankshaft of the internal combustion engine 110.

Still referring to FIG. 1, the electrical energy storage device 150 stores electrical energy that may be provided to various components of the hybrid vehicle 100, including the first motor-generator 120 and the second motor-generator 130. In some embodiments, the electrical energy storage device 150 includes one or more batteries, such as lithium-ion batteries. In some embodiments, the electrical energy storage device 150 includes one or more high capacity capacitors (sometimes referred to as “supercapacitors” or “ultracapacitors”). In some embodiments, the electrical energy storage device includes a electrical energy storage device (e.g., one or more batteries) and a secondary electrical energy storage device (e.g., one or more capacitors).

Still referring to FIG. 1, the electrical energy distribution device 160 includes a first electrical energy port 162, a second electrical energy port 164, and a third electrical energy port 166. The first electrical energy port 162 of the electrical energy distribution device 160 is electrically coupled to the electrical energy storage device 150. The second electrical energy port 164 of the electrical energy distribution device 160 is electrically coupled to the electrical energy port 122 of the first motor-generator 120. The third electrical energy port 166 of the electrical energy distribution device 160 is electrically coupled to the electrical energy port 132 of the second motor-generator 130. As will be more fully described below, the electrical energy distribution device 160 distributes electrical energy from the electrical energy storage device 150 to the first motor-generator 120 and/or the second motor-generator 130 (e.g., when the first motor-generator 120 and/or the second motor-generator 130 operate in the motor mode), as well as distributes electrical energy from the first motor-generator 120 and the second motor-generator 130 to the electrical energy storage device 150 (e.g., when the first motor-generator 120 and/or the second motor-generator 130 operate in the generator mode).

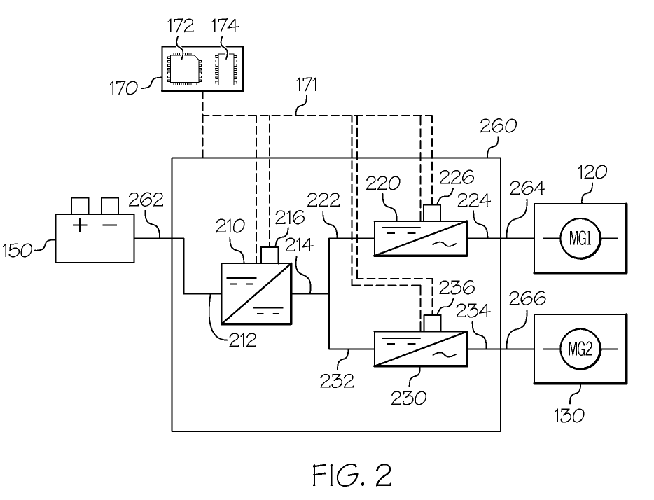

Still referring to the electrical energy distribution device 160 of FIG. 1, in some embodiments, the electrical energy distribution device 160 includes one or more DC-DC converters that outputs electrical energy at a voltage different from a voltage of electrical energy received by the DC-DC converter. In some embodiments, the electrical energy distribution device 160 includes one or more inverters for converting between direct current and alternating current, such as then when one or more inverters converts between direct current received by the electrical energy distribution device and alternating current output by the electrical energy distribution device, or vice-versa. FIG. 2, described in detail below, depict some embodiments of such electrical energy distribution devices that include one or more DC-DC converters and one or more inverters.

Referring now to FIG. 2, an electrical energy distribution device 260 is schematically depicted. In some embodiments, the electrical energy distribution device 160 of FIG. 1 is the electrical energy distribution device 260 depicted in FIG. 2. The electrical energy distribution device 260 depicted in FIG. 2 includes a first electrical energy port 262, a second electrical energy port 264, a third electrical energy port 266, a DC-DC converter 210, a first inverter 220, a second inverter 230, a DC-DC converter current sensor 216, a first inverter current sensor 226, and a second inverter current sensor 236. The first electrical energy port 262 of the electrical energy distribution device 260 is electrically coupled to the electrical energy storage device 150. The second electrical energy port 264 of the electrical energy distribution device 260 is electrically coupled to the electrical energy port of the first motor-generator 120. The third electrical energy port 266 of the electrical energy distribution device 260 is electrically coupled to the electrical energy port of the second motor-generator 130.

Still referring to the electrical energy distribution device 260 depicted in FIG. 2, the first electrical energy port 262 is electrically coupled to a first electrical energy port 212 of the DC-DC converter 210, thereby electrically coupling the DC-DC converter 210 to the electrical energy storage device 150. The DC-DC converter 210 converts voltage such that a voltage at the first electrical energy port 212 of the DC-DC converter 210 is different than a voltage at the second electrical energy port 214 of the DC-DC converter 210. For example, in some embodiments, a voltage at the first electrical energy port 212 may be lower than a voltage at the second electrical energy port 214. The DC-DC converter current sensor 216 is communicatively coupled to the electronic control unit 170, is coupled to the DC-DC converter 210, and is operable to sense an amount of current flowing through the DC-DC converter 210. In some embodiments, the DC-DC converter current sensor 216 is a hall effect sensor, though embodiments are not limited thereto.

Still referring to FIG. 2, the second electrical energy port 214 of the DC-DC converter 210 is electrically coupled to a first electrical energy port 222 of the first inverter 220 and electrically coupled to a first electrical energy port 232 of the second inverter 230, thereby electrically coupling the DC-DC converter 210 to both the first inverter 220 and the second inverter 230. A second electrical energy port 224 of the first inverter 220 is electrically coupled to the electrical energy port of the first motor-generator 120, thereby electrically coupling the first inverter 220 to the first motor-generator 120. A second electrical energy port 234 of the second inverter 230 is electrically coupled to the electrical energy port of the second motor-generator 130, thereby electrically coupling the second inverter 230 to the second motor-generator 130. The first inverter 220 converts between direct current at the first electrical energy port 222 and alternating current at the second electrical energy port 224. The second inverter 230 converts between direct current at the first electrical energy port 232 and alternating current at the second electrical energy port 234. The first inverter current sensor 226 is coupled to the first inverter 220 and is operable to sense a first amount of current flowing through the first inverter 220 (e.g., an amount of current being provided to or received from the first motor-generator 120). The second inverter current sensor 236 is coupled to the second inverter 230 and is operable to sense a second amount of current flowing through the second inverter 230 (e.g., an amount of current being provided to or received from the second motor-generator 130). In some embodiments, each of the first inverter current sensor 226 and the second inverter current sensor 236 are hall effect current sensors, though embodiments are not limited thereto.

Still referring to FIG. 2, each of the DC-DC converter 210, the first inverter 220, and the second inverter 230 are communicatively coupled to the electronic control unit 170 via the communication path 171. Machine readable instructions stored in the one or more memory modules 174 of the electronic control unit 170, when executed by the one or more processors 172 of the electronic control unit 170, cause command signals to be provided to the DC-DC converter 210, the first inverter 220, and the second inverter 230 (e.g., command signals to control one or more power transistors included in each of the DC-DC converter 210, the first inverter 220, and the second inverter 230) to control the distribution of power among the electrical energy storage device 150, the first motor-generator 120, and the second motor-generator 130. In particular, in some embodiments in which the first motor-generator 120 and the second motor-generator 130 operate in the motor mode, the DC-DC converter 210 steps up the voltage of the direct current electrical energy received from the electrical energy storage device 150 into a higher voltage direct current output, and each of the first inverter 220 and the second inverter 230 converts the higher voltage direct current output of the DC-DC converter 210 to alternating current for driving the first motor-generator 120 and the second motor-generator 130. Conversely, in some embodiments in which the first motor-generator 120 and the second motor-generator 130 operate in the generator mode, each of the first inverter 220 and the second inverter 230 convert alternating current received from the first motor-generator 120 and the second motor-generator 130 into a direct current output, and the DC-DC converter 210 converts the direct current output by the first inverter 220 and the second inverter 230 into lower voltage direct current electrical energy that may be channeled to the electrical energy storage device 150 for storage and later use.

While the DC-DC converter 210 is described above as having a higher voltage at the first electrical energy port 212 than at the second electrical energy port 214, in other embodiments, the DC-DC converter 210 has a lower voltage at the first electrical energy port 212 than at the second electrical energy port 214. Furthermore, some embodiments of the electrical energy distribution device 260 do not include the DC-DC converter 210, such as embodiments in which the electrical energy storage device 150 is electrically coupled to the first inverter 220 and/or the second inverter 230 without an intermediary DC-DC converter. Furthermore, some embodiments do not include the first inverter 220 and/or the second inverter 230, such as embodiments in which the first motor-generator 120 and the second motor-generator 130 are induction motor-generators driven by direct current. Furthermore, some embodiments of the electrical energy distribution device 260 may not include any DC-DC converters or inverters, such as embodiments in which the first motor-generator 120 and the second motor-generator 130 are induction motors driven by direct current having the same voltage as the electrical energy storage device 150.

While particular examples of electrical energy distribution devices were depicted and described with reference to FIG. 2, it should be understood that in other embodiments, the electrical energy distribution device 160 of FIG. 1 may include additional or fewer components or components arranged differently than the electrical energy distribution devices depicted in FIG. 2.

Referring once again to FIG. 1, the communication path 171 communicatively couples a number of the electronic components of the hybrid vehicle 100. In particular, the communication path 171 communicatively couples the electronic control unit 170, the internal combustion engine 110, the electrical energy distribution device 160, an engine rotational speed sensor 176, a first motor-generator rotational speed sensor 178, a second motor-generator rotational speed sensor 180, an accelerator pedal position sensor 182, a brake pedal position sensor 184, a vehicle speed sensor 186, a vehicle acceleration sensor 188, an electrical energy storage device state of charge sensor 190, and a plurality of wheel speed sensors 192.

Still referring to FIG. 1, the communication path 171 may be formed from any medium that is capable of transmitting a signal such as, for example, conductive wires, conductive traces, optical waveguides, or the like. Moreover, the communication path 171 may be formed from a combination of mediums capable of transmitting signals. In some embodiments, the communication path 171 comprises a combination of conductive traces, conductive wires, connectors, and buses that cooperate to permit the transmission of electrical data signals to components such as processors, memories, sensors, input devices, output devices, and communication devices. Accordingly, the communication path 171 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 171 communicatively couples the various components of the hybrid vehicle 100. As used herein, the term “communicatively coupled” means that coupled components are capable of exchanging data signals with one another such as, for example, electrical signals via conductive medium, electromagnetic signals via air, optical signals via optical waveguides, and the like.

Still referring to FIG. 1, the electronic control unit 170 includes one or more processors 172 and one or more memory modules 174 communicatively coupled to the one or more processors 172. Each of the one or more processors 172 of the electronic control unit 170 may be any device capable of executing machine readable instructions. Accordingly, each of the one or more processors 172 may be a controller, an integrated circuit, a microchip, a computer, or any other computing device. The one or more processors 172 are communicatively coupled to the other components of the hybrid vehicle 100 by the communication path 171. Accordingly, the communication path 171 may communicatively couple any number of processors with one another, and allow the components coupled to the communication path 171 to operate in a distributed computing environment. Specifically, each of the components may operate as a node that may send and/or receive data.

Each of the one or more memory modules 174 of the hybrid vehicle 100 is coupled to the communication path 171 and communicatively coupled to the one or more processors 172. The one or more memory modules 174 may comprise RAM, ROM, flash memories, hard drives, non-transitory storage media, or any device capable of storing machine readable instructions such that the machine readable instructions can be accessed and executed by the one or more processors 172. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 174. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

As noted above, the hybrid vehicle 100 includes a number of sensors, including the engine rotational speed sensor 176, the first motor-generator rotational speed sensor 178, the second motor-generator rotational speed sensor 180, the accelerator pedal position sensor 182, the brake pedal position sensor 184, the vehicle speed sensor 186, the vehicle acceleration sensor 188, the electrical energy storage device state of charge sensor 190, and the plurality of wheel speed sensors 192. The engine rotational speed sensor 176 outputs an engine rotational speed signal (N_{E}) indicative of a rotational speed of the crankshaft 112 of the internal combustion engine 110. The first motor-generator rotational speed sensor 178 outputs a first motor-generator rotational speed signal (N_{MG1}) indicative of a rotational speed of the output shaft 124 of the first motor-generator 120. The second motor-generator rotational speed sensor 180 outputs a second motor-generator rotational speed signal (N_{MG2}) indicative of a rotational speed of the output shaft 134 of the second motor-generator 130. The accelerator pedal position sensor 182 outputs an accelerator pedal position signal (P_{accel}) indicative of a position of an accelerator pedal of the hybrid vehicle 100. The brake pedal position sensor 184 outputs a brake pedal position signal (P_{brake}) indicative of a position of a brake pedal of the hybrid vehicle 100. The vehicle speed sensor 186 outputs a speed signal (v) indicative of a speed of the hybrid vehicle 100. The vehicle acceleration sensor 188 outputs an acceleration signal (α) indicative of an acceleration of the hybrid vehicle 100. The electrical energy storage device state of charge sensor 190 outputs a state of charge signal (SOCₚ) indicative of a state of charge of the electrical energy storage device 150. Each of the plurality of wheel speed sensors 192 is associated with a corresponding one of the plurality of drive wheels 102. Each of the plurality of wheel speed sensors 192 outputs a wheel speed signal indicative of a wheel speed of the corresponding drive wheel of the plurality of drive wheels 102. In some embodiments, the hybrid vehicle 100 may not include one or more of the sensors depicted in FIG. 1 and/or may include sensors other than the sensors depicted in FIG. 1.

As noted above, while FIG. 1 depicts a hybrid vehicle 100, the internal combustion engine control methods described below are not limited to hybrid vehicles. The internal engine control methods described below are applicable to other classes of vehicles, such as conventional vehicles. For example, referring to FIG. 3, a vehicle 300 to which the below described methods are also applicable is depicted. The vehicle 300 includes a number of the components described above with reference to FIG. 1, including the internal combustion engine 110 having the crankshaft 112, the differential gear 115, the plurality of drive wheels 102, the communication path 171, the electronic control unit 170, the engine rotational speed sensor 176, the accelerator pedal position sensor 182, the brake pedal position sensor 184, the vehicle speed sensor 186, the vehicle acceleration sensor 188, and the plurality of wheel speed sensors 192. As shown in FIG. 3, the crankshaft 112 of the internal combustion engine 110 is mechanically coupled to the plurality of drive wheels 102 via the differential gear 115. One or more intervening mechanical components (e.g., one or more clutches, one or more transmissions, one or more reduction gears, etc.) may be in the mechanical path between the crankshaft 112 and the plurality of drive wheels 102. The communication path 171 communicatively couples the electronic control unit 170 to the internal combustion engine 110, the engine rotational speed sensor 176, the accelerator pedal position sensor 182, the brake pedal position sensor 184, the vehicle speed sensor 186, the vehicle acceleration sensor 188, and the plurality of wheel speed sensors 192.

Having described various embodiments of hybrid vehicles and conventional vehicles, methods of controlling a rotational speed of the internal combustion engine of such embodiments will now be described.

Referring now to FIG. 4 in conjunction with FIGS. 1 and 3, a method 400 is schematically depicted. Although the steps associated with the blocks of FIG. 4 will be described as being separate tasks, in other embodiments, the blocks may be combined or omitted. Further, while the steps associated with the blocks of FIG. 4 will be described as being performed in a particular order, in other embodiments, the steps may be performed in a different order.

At block 402, the machine readable instructions stored in the one or more memory modules 174, when executed by the one or more processors 172, cause the electronic control unit 170 to determine whether an acceleration event is detected. In some embodiments, the electronic control unit 170 determines whether an acceleration event is detected based on the accelerator pedal position sensor output signal (P_{accel}) that is output by the accelerator pedal position sensor 182. For example, some embodiments may determine that an acceleration event is detected when P_{accel} changes by a threshold amount in a period of time. In some embodiments, the electronic control unit 170 determines whether an acceleration event is detected based on a requested torque, a requested acceleration amount, or based on one or more other sensed or calculated vehicle operation parameters. In some embodiments in which the vehicle is an autonomous vehicle, the electronic control unit 170 determines whether an acceleration event is detected without input from a driver. Some embodiments may not determine whether an acceleration event is detected, such as embodiments in which the engine rotational speed of the internal combustion engine 110 is controlled during conditions in which an acceleration event is not taking place.

Still referring to FIG. 4 in conjunction with FIGS. 1 and 3, if an acceleration event is not detected at block 402, the method returns to block 402 and determines again whether an acceleration event is detected. In some embodiments in which the vehicle is a hybrid vehicle (such as the hybrid vehicle 100 depicted in FIG. 1), the electrical energy storage device 150 may be charged before the next acceleration event is detected, such as in embodiments in which the first motor-generator 120 and the second motor-generator 130 operate in the generator mode and the electrical energy distribution device 160 converts alternating current received from the first motor-generator 120 and the second motor-generator 130 into a direct current output that may be channeled to the electrical energy storage device 150 for storage and later use.

Still referring to FIG. 4 in conjunction with FIGS. 1 and 3, if an acceleration event is detected at block 402, the machine readable instructions stored in the one or more memory modules 174, when executed by the one or more processors 172, cause the electronic control unit 170 to determine a target wheel torque at block 404.

Still referring to block 404, in some embodiments, the target wheel torque is determined based on a requested acceleration amount and a vehicle speed. In some embodiments in which the target wheel torque is determined based on a requested acceleration amount, the machine readable instructions stored in the one or more memory modules 174, when executed by the one or more processors 172, cause the electronic control unit 170 to determine the requested acceleration amount. In some embodiments, the requested acceleration amount is determined based on the accelerator pedal position sensor output signal (P_{accel}) that is output by the accelerator pedal position sensor 182. In some embodiments, the requested acceleration amount is determined to be proportional to the accelerator position sensor output signal (P_{accel}). In some embodiments, the requested acceleration amount is determined as a function of the accelerator position sensor output signal (P_{accel}). In some embodiments, the requested acceleration amount may be determined based on a requested torque, a requested acceleration amount, or based on one or more other sensed or calculated vehicle operation parameters. In some embodiments in which the vehicle is an autonomous vehicle, the requested acceleration amount may be determined automatically by the electronic control unit 170 without input from a driver. In some embodiments in which the target wheel torque is determined based on a vehicle speed, the machine readable instructions stored in the one or more memory modules 174, when executed by the one or more processors 172, cause the electronic control unit 170 to determine the vehicle speed. In some embodiments, the vehicle speed may be determined based on the vehicle speed (v) output signal provided by the vehicle speed sensor 186. In some embodiments, the vehicle speed may be determined as a function of the rotation speed of the output shaft 134 of the second motor-generator 130 (N_{MG2}) output signal provided by the second motor-generator rotational speed sensor 180. In other embodiments, the vehicle speed may be determined differently, such as when the vehicle speed is determined as a function of the wheel speed signals output by the plurality of wheel speed sensors 194, or the like.

Still referring to block 404, in some embodiments, the target wheel torque is determined based on an acceleration profile stored in the one or more memory modules. In some embodiments, the acceleration profile may map a vehicle speed and a requested acceleration amount to a particular target wheel torque. In some embodiments, the acceleration profile may be determined based on a requested acceleration amount and a vehicle speed, and the target wheel torque may be determined based on the target acceleration profile. In some hybrid vehicle embodiments, the acceleration profiles may define a relative distribution of power from the electrical energy storage device 150 to the first motor-generator 120 and the second motor-generator 130 based on a requested acceleration amount and a vehicle speed. For example, when a requested acceleration amount is relatively large and a vehicle speed is relatively high (e.g., as may be encountered when a vehicle is merging onto a highway), the acceleration profile may cause the electronic control unit 170 to direct more electrical energy to the first motor-generator 120 than to the second motor-generator 130 in order to increase the engine rotational speed of the internal combustion engine 110 and overcome the engine inertia, allowing the vehicle to achieve peak acceleration quickly, even though the vehicle may experience a lag at the beginning of the acceleration event or a 2-step acceleration profile. Conversely, when a requested acceleration amount is relatively small and a vehicle speed is relatively low (e.g., as may be encountered when a vehicle needs to accelerate at low speed in heavy traffic), the acceleration profile may cause the electronic control unit 170 to direct more electrical energy to the second motor-generator 130 than to the first motor-generator 120 in order to deliver more immediate drive torque to the plurality of drive wheels 102, which may mitigate any lag at the beginning of the acceleration event and allow the vehicle to reach the desired speed more smoothly, even though it may take longer to achieve a top target speed.

Still referring to block 404, in some embodiments, the target wheel torque is determined as a function of vehicle speed (such as when the target wheel torque is determined as a function of the vehicle speed signal (v) output by the vehicle speed sensor 186) and/or vehicle acceleration (such as when the target wheel torque is determined as a function of the acceleration signal (α) output by the vehicle acceleration sensor 188). In some embodiments, the target wheel torque is determined from a look-up table or based on an algorithm that uses one or more calculated or sensed vehicle parameters as inputs and outputs the target wheel torque.

In some embodiments, the electronic control unit 170 also determines a target engine speed in addition to determining the target wheel torque. The target engine speed may be determined in a variety of ways similar to those described above with respect to determining the target wheel torque. For example, the target engine speed may be determined based on a vehicle acceleration amount, based on a vehicle speed, based on a requested acceleration amount, based on a vehicle speed and a requested acceleration amount, based on an acceleration profile, or the like.

Still referring to FIG. 4 in conjunction with FIGS. 1 and 3, at block 406, the machine readable instructions stored in the one or more memory modules 174, when executed by the one or more processors 172, cause the electronic control unit 170 to determine a base increase rate of engine rotational speed. In some embodiments, the base increase rate of engine rotational speed may be determined as a function of a requested acceleration amount, as a function of vehicle speed, as a function of vehicle speed and requested acceleration amount, as a function of target engine speed, or as a function of one or more other sensed or calculated vehicle parameters. In some embodiments, the base increase rate is determined by accessing a look-up table that maps a requested acceleration amount and a vehicle speed to a base increase rate. In some embodiments, the base increase rate is determined from an acceleration profile, such as the acceleration profiles described above with reference to block 404.

Still referring to FIG. 4 in conjunction with FIGS. 1 and 3, at block 408, the machine readable instructions stored in the one or more memory modules 174, when executed by the one or more processors 172, cause the electronic control unit 170 to increase an engine rotational speed of the internal combustion engine 110 based on the base increase rate of engine rotational speed determined at block 406. In some embodiments, the electronic control unit 170 increases the engine rotational speed of the internal combustion engine 110 at the base increase rate of engine rotational speed. Some embodiments may utilize a closed loop control scheme that effectuates an increase of the sensed engine rotational speed signal (N_{E}) output by the engine rotational speed sensor 176 by the base increase rate.

In some embodiments in which the vehicle is a hybrid vehicle (e.g., the hybrid vehicle 100 depicted in FIG. 1), the electronic control unit 170 may increase the engine rotational speed of the internal combustion engine 110 by controlling an amount of electrical energy provided from the electrical energy storage device 150 to the first motor-generator 120 based on the base increase rate of engine rotational speed. In some embodiments, the electronic control unit 170 controls an amount of electrical energy provided from the electrical energy storage device 150 to the first motor-generator 120 in order to increase the engine rotational speed by the base increase rate of engine rotational speed. In some embodiments, the machine readable instructions stored in the one or more memory modules 174, when executed by the one or more processors 172, cause the electronic control unit 170 to provide command signals to the electrical energy distribution device 160 in order to control the amount of electrical energy provided to the first motor-generator 120. In some embodiments that include the electrical energy distribution device 260 of FIG. 2, the machine readable instructions stored in the one or more memory modules 174, when executed by the one or more processors 172, cause the electronic control unit 170 to provide a first inverter command signal to the first inverter 220 and to provide a DC-DC converter command signal to the DC-DC converter 210 in order to provide the electrical energy to the first motor-generator 120. In some embodiments, the amount of electrical energy to be provided to the first motor-generator 120 is determined as a quantity of current to be output to the electrical energy port 122 of the first motor-generator 120. Some embodiments may control the quantity of current output to the electrical energy port 122 of the first motor-generator 120 using a closed loop control scheme that utilizes a sensed current signal received by the electronic control unit 170 (e.g., a sensed current signal received from the first inverter current sensor 226 (FIG. 2)). When the first amount of electrical energy is provided to the first motor-generator 120, a rotational speed of the output shaft 124 of the first motor-generator 120 is increased, which causes the plurality of planetary gears 144 and the carrier 146 that is mechanically coupled to the plurality of planetary gears 144 to rotate, which in turn causes the crankshaft 112 of the internal combustion engine 110 to rotate at an increased speed, thereby increasing the engine rotational speed of the internal combustion engine 110.

In some embodiments in which the vehicle is a conventional vehicle (i.e., not a hybrid vehicle), the electronic control unit 170 may increase the engine rotational speed of the internal combustion engine 110 by controlling one or more actuators having an influence on the engine rotational speed of the internal combustion engine 110 using an open loop or closed loop control scheme.

Still referring to FIG. 4 in conjunction with FIGS. 1 and 3, at block 410, the machine readable instructions stored in the one or more memory modules 174, when executed by the one or more processors 172, cause the electronic control unit 170 to determine an estimated wheel torque. In some embodiments, the estimated wheel torque may be determined as a function of the wheel speed signals output by the plurality of wheel speed sensors 194. In other embodiments, the electronic control unit 170 determines the estimated wheel torque based on one or more other sensed or calculated vehicle parameters.

Still referring to block 410, in some embodiments in which the vehicle is a hybrid vehicle (e.g., the hybrid vehicle 100 depicted in FIG. 1), the electronic control unit 170 determines an estimated output torque of the first motor-generator 120 based on a sensed first amount of current output by the first inverter current sensor 226, determines a first amount of estimated torque transferred to the plurality of drive wheels 102 based on the estimated output torque of the first motor-generator 120 (the first amount of estimated torque in turn may be determined based on a gear ratio of the mechanical power distribution apparatus 140), determines an estimated output torque of the second motor-generator 130 based on a second amount of current sensed by the second inverter current sensor 236, and determines the estimated wheel torque to be the sum of the first amount of estimated torque transferred to the plurality of drive wheels 102 from the first motor-generator and the estimated output torque of the second motor-generator 130. In other embodiments, the estimated wheel torque may be determined differently, such as when the estimated wheel torque is determined as a function of the first motor-generator rotational speed signal (N_{MG1}) output by the first motor-generator rotational speed sensor 178 and the second motor-generator rotational speed signal (N_{MG2}) output by the second motor-generator rotational speed sensor 180.

Still referring to FIG. 4 in conjunction with FIGS. 1 and 3, at block 412, the machine readable instructions stored in the one or more memory modules 174, when executed by the one or more processors 172, cause the electronic control unit 170 to determine an updated increase rate of engine rotational speed based on the target wheel torque and the estimated wheel torque. In some embodiments, the electronic control unit 170 determines a difference between the target wheel torque and the estimated wheel torque, and determines the updated increase rate of target engine rotational speed based on the difference, such as when the updated increase rate of target engine rotational speed is a function of the difference. For example, in some embodiments, the updated increase rate of engine rotational speed is the base increase rate of engine rotational speed plus or minus an amount calculated based on the difference of target wheel torque and estimated wheel torque. In other embodiments, the updated increase rate of engine rotational speed may be determined differently.

Still referring to block 412, in some embodiments, the electronic control unit 170 determines the updated increase rate of engine rotational speed to be greater than the base increase rate of engine rotational speed when the estimated wheel torque is greater than the target wheel torque. In some embodiments, the updated increase rate of engine rotational speed is the base increase rate of engine rotational speed plus an amount proportional to the difference between the estimated wheel torque and the target wheel torque. In the case of a hybrid vehicle, such as the hybrid vehicle 100 depicted in FIG. 1, increasing the increase rate of engine rotational speed relative to the base increase rate causes more electrical energy from the electrical energy storage device 150 to be directed to the first motor-generator 120 than the second motor-generator 130 in order to more quickly raise the engine speed of the internal combustion engine 110, which leaves less electrical energy to be provided to the second motor-generator 130 to be immediately provided to the plurality of drive wheels 102, thereby closing the difference in estimated wheel torque and target wheel torque.

Still referring to block 412, in some embodiments, the electronic control unit 170 determines the updated increase rate of engine rotational speed to be less than the base increase rate of engine rotational speed when the estimated wheel torque is less than the target wheel torque. In some embodiments, the updated increase rate of engine rotational speed is the base increase rate of engine rotational speed minus an amount proportional to the difference between the target wheel torque and the estimated wheel torque. In the case of a hybrid vehicle, such as the hybrid vehicle 100 depicted in FIG. 1, decreasing the increase rate of engine rotational speed relative to the base increase rate of engine rotational speed allows more electrical energy from the electrical energy storage device 150 to be directed to the second motor-generator 130 to immediately provide drive torque to the plurality of drive wheels 102 and to close the difference in target wheel torque and estimated wheel torque.

Still referring to FIG. 4 in conjunction with FIGS. 1 and 3, at block 414, the machine readable instructions stored in the one or more memory modules 174, when executed by the one or more processors 172, cause the electronic control unit 170 to increase the engine rotational speed of the internal combustion engine 110 based on the updated increase rate of engine rotational speed. The engine rotational speed of the internal combustion engine 110 may be increased based on the updated increase rate of engine rotational speed in the same manner as the engine rotational speed of the internal combustion engine 110 is increased based on the base increase rate of engine rotational speed described above with respect to block 408. In some embodiments in which the vehicle is a hybrid vehicle (e.g., the hybrid vehicle 100 depicted in FIG. 1), the electronic control unit 170 increases the engine rotational speed of the internal combustion engine 110 by controlling the amount of electrical energy provided from the electrical energy storage device 150 to the first motor-generator 120 based on the updated increase rate of engine rotational speed.

Still referring to FIG. 4 in conjunction with FIGS. 1 and 3, at block 416, the machine readable instructions stored in the one or more memory modules 174, when executed by the one or more processors 172, cause the electronic control unit 170 to determine whether the acceleration event has ended. In some embodiments, the electronic control unit 170 determines that the acceleration event has ended based on the accelerator pedal position sensor P_{accel}. In some embodiments, the electronic control unit 170 determines that the acceleration event has ended when a sensed or calculated wheel torque equals the target wheel torque or when a sensed or calculated engine speed equals the target engine speed. In other embodiments, the electronic control unit 170 determines whether an acceleration event has ended differently. Furthermore, some embodiments may not include block 416, such as embodiments that control the engine rotational speed independent of whether an acceleration event has ended.

It should be understood that the embodiments described herein determine a target wheel torque, determine a base increase rate of engine rotational speed, increase an engine rotational speed of the internal combustion engine based on the base increase rate of engine rotational speed, determine an estimated wheel torque, determine an updated increase rate of engine rotational speed based on the target wheel torque and the estimated wheel torque, and increase the engine rotational speed of the internal combustion engine based on the updated increase rate of engine rotational speed. By adaptively changing the increase rate of engine rotational speed based on estimated wheel torque and target wheel torque as described herein, vehicles may achieve a smoother acceleration profile in some instances and may achieve a variety of acceleration profiles under different driving conditions. Furthermore, embodiments described herein may provide for different acceleration profiles under different driving conditions (e.g. different acceleration profiles at different requested vehicle acceleration amounts and vehicle speeds), which may allow for achieving a target top speed more quickly in some instances despite a potential acceleration lag (e.g., when merging onto a highway at a higher vehicle speed), and may allow for achieving an initial acceleration quickly with reduced lag despite a longer time to reach a top target speed (e.g., when driving in heavy traffic at a lower vehicle speed).

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
one or more processors;
one or more memory modules communicatively coupled to the one or more processors;
an internal combustion engine comprising a crankshaft, wherein the internal combustion engine is communicatively coupled to the one or more processors;
a plurality of drive wheels mechanically coupled to the crankshaft of the internal combustion engine; and
machine readable instructions stored in the one or more memory modules that cause the vehicle to perform at least the following when executed by the one or more processors:
determine a target wheel torque;
determine a base increase rate of engine rotational speed;
increase an engine rotational speed of the internal combustion engine based on the base increase rate of engine rotational speed;
determine an estimated wheel torque;
determine an updated increase rate of engine rotational speed based on the target wheel torque and the estimated wheel torque; and
increase the engine rotational speed of the internal combustion engine based on the updated increase rate of engine rotational speed.

2. The vehicle of claim 1, wherein the machine readable instructions, when executed by the one or more processors, cause the vehicle to:
determine a requested acceleration amount;
determine a vehicle speed; and
determine the target wheel torque based on the requested acceleration amount and the vehicle speed.

3. The vehicle of claim 2, wherein the machine readable instructions, when executed by the one or more processors, cause the vehicle to:
determine a target acceleration profile based on the requested acceleration amount and the vehicle speed; and
determine the target wheel torque based on the target acceleration profile.

4. The vehicle of claim 2, further comprising:
an accelerator pedal position sensor communicatively coupled to the one or more processors and outputting an accelerator pedal position signal (P_{accel}) indicative of a position of an accelerator pedal;
wherein the machine readable instructions, when executed by the one or more processors, cause the vehicle to:
determine the requested acceleration amount based on the accelerator pedal position signal (P_{accel}).

5. The vehicle of claim 1, further comprising:
at least one wheel speed sensor communicatively coupled to the one or more processors and outputting a wheel speed signal indicative of a speed of at least one of the plurality of drive wheels;
wherein the machine readable instructions, when executed by the one or more processors, cause the vehicle to:
determine the estimated wheel torque based on the wheel speed signal.

6. The vehicle of claim 1, wherein the machine readable instructions, when executed by the one or more processors, cause the vehicle to:
determine the updated increase rate of engine rotational speed to be greater than the base increase rate of engine rotational speed when the estimated wheel torque is greater than the target wheel torque.

7. The vehicle of claim 1, wherein the machine readable instructions, when executed by the one or more processors, cause the vehicle to:
determine the updated increase rate of engine rotational speed to be less than the base increase rate of engine rotational speed when the estimated wheel torque is less than the target wheel torque.

8. The vehicle of claim 1, wherein the machine readable instructions, when executed by the one or more processors, cause the vehicle to:
determine a difference between the target wheel torque and the estimated wheel torque; and
determine the updated increase rate of target engine rotational speed based on the difference.

9. A hybrid vehicle comprising:
one or more processors;
one or more memory modules communicatively coupled to the one or more processors;
a mechanical power distribution apparatus comprising a sun gear, a plurality of planetary gears, a carrier, and a ring gear, wherein the plurality of planetary gears mesh with the ring gear and the sun gear, wherein the plurality of planetary gears are mechanically coupled to the carrier;
an internal combustion engine comprising a crankshaft, wherein the crankshaft is mechanically coupled to the carrier of the mechanical power distribution apparatus;
a plurality of drive wheels;
a first motor-generator comprising an output shaft, wherein the output shaft of the first motor-generator is mechanically coupled to the sun gear;
a second motor-generator comprising an output shaft, wherein the output shaft of the second motor-generator is mechanically coupled to the plurality of drive wheels and is mechanically coupled to the ring gear;
an electrical energy storage device electrically coupled to the first motor-generator and the second motor-generator such that the electrical energy storage device can provide electrical energy to the first motor-generator and the second motor-generator; and
machine readable instructions stored in the one or more memory modules that cause the hybrid vehicle to perform at least the following when executed by the one or more processors:
determine a target wheel torque;
determine a base increase rate of engine rotational speed;
increase an engine rotational speed of the internal combustion engine by controlling an amount of electrical energy provided from the electrical energy storage device to the first motor-generator based on the base increase rate of engine rotational speed;
determine an estimated wheel torque;
determine an updated increase rate of engine rotational speed based on the target wheel torque and the estimated wheel torque; and
increase the engine rotational speed of the internal combustion engine by controlling the amount of electrical energy provided from the electrical energy storage device to the first motor-generator based on the updated increase rate of engine rotational speed.

10. The hybrid vehicle of claim 9, wherein the machine readable instructions, when executed by the one or more processors, cause the hybrid vehicle to:
determine a requested acceleration amount;
determine a vehicle speed; and
determine the target wheel torque based on the requested acceleration amount and the vehicle speed.

11. The hybrid vehicle of claim 10, wherein the machine readable instructions, when executed by the one or more processors, cause the hybrid vehicle to:
determine a target acceleration profile based on the requested acceleration amount and the vehicle speed; and
determine the target wheel torque based on the target acceleration profile.

12. The hybrid vehicle of claim 9, wherein the machine readable instructions, when executed by the one or more processors, cause the hybrid vehicle to:
determine the updated increase rate of engine rotational speed to be greater than the base increase rate of engine rotational speed when the estimated wheel torque is greater than the target wheel torque.

13. The hybrid vehicle of claim 9, wherein the machine readable instructions, when executed by the one or more processors, cause the hybrid vehicle to:
determine the updated increase rate of engine rotational speed to be less than the base increase rate of engine rotational speed when the estimated wheel torque is less than the target wheel torque.

14. The hybrid vehicle of claim 9, wherein the machine readable instructions, when executed by the one or more processors, cause the hybrid vehicle to:
determine a difference between the target wheel torque and the estimated wheel torque; and
determine the updated increase rate of target engine rotational speed based on the difference.

15. The hybrid vehicle of claim 9, further comprising:
a first current sensor for sensing a first amount of current provided to the first motor-generator; and
a second current sensor for sensing a second amount of current provided to the second motor-generator;
wherein the machine readable instructions, when executed by the one or more processors, cause the hybrid vehicle to:
determine an estimated output torque of the first motor-generator based on the sensed first amount of current;
determine a first amount of estimated torque transferred to the plurality of drive wheels based on the estimated output torque of the first motor-generator;
determine an estimated output torque of the second motor-generator based on the sensed second amount of current; and
determine the estimated wheel torque to be a sum of the first amount of estimated torque transferred to the plurality of drive wheels and the estimated output torque of the second motor-generator.

16. The hybrid vehicle of claim 15, wherein the machine readable instructions, when executed by the one or more processors, cause the hybrid vehicle to:
determine the first amount of estimated torque transferred to the plurality of drive wheels based on a gear ratio of the mechanical power distribution apparatus.

17. A method for controlling an engine rotational speed of an internal combustion engine, the method comprising:
determining a target wheel torque;
determining a base increase rate of engine rotational speed;
increasing the engine rotational speed of the internal combustion engine based on the base increase rate of engine rotational speed;
determining an estimated wheel torque;
determining an updated increase rate of engine rotational speed based on the target wheel torque and the estimated wheel torque; and
increasing the engine rotational speed of the internal combustion engine based on the updated increase rate of engine rotational speed.

18. The method of claim 17, further comprising:
determining a requested acceleration amount;
determining a vehicle speed; and
determining the target wheel torque based on the requested acceleration amount and the vehicle speed.

19. The method of claim 18, further comprising:
determining a target acceleration profile based on the requested acceleration amount and the vehicle speed; and
determining the target wheel torque based on the target acceleration profile.

20. The method of claim 17, further comprising:
determining the updated increase rate of engine rotational speed to be greater than the base increase rate of engine rotational speed when the estimated wheel torque is greater than the target wheel torque; and
determining the updated increase rate of engine rotational speed to be less than the base increase rate of engine rotational speed when the estimated wheel torque is less than the target wheel torque.
